(19) United States
(12) Patent Application Publication
(10) Pub. No.: US 2008/0084105 A1
(43) Pub. Date: Apr. 10, 2008

(54) VEHICLE SEAT

(75) Inventor: Meinhard Behrens, Obernkirchen (DE)

Correspondence Address: BARNES & THORNBURG LLP, 11 SOUTH MERIDIAN, INDIANAPOLIS, IN, 46204, US

(73) Assignee: FAURECIA AUTOSITZE GMBH, Stadthagen (DE)

(21) Appl. No.: 11/861,077

(22) Filed: Sep. 25, 2007

(30) Foreign Application Priority Data
Oct. 10, 2006 (DE) 10 2006 047 868.1

(51) Int. Cl. A47C 5/00; B68G 7/12

(52) U.S. Cl. 297/452.55; 29/91.1

(57) ABSTRACT

The invention relates to a vehicle seat, in particular for a motor vehicle, wherein the vehicle seat comprises padding and a profile or panel which comprises a padding channel for the fastening of the padding and/or of a cover, and wherein the padding channel comprises a tab which protrudes into the padding channel in such a manner that it increasingly narrows the latter in one section (V) in the longitudinal direction of the padding channel.

The invention relates to a vehicle seat, in particular for a motor vehicle, wherein the vehicle seat comprises padding and a profile or panel which comprises a padding channel for the fastening of the padding and/or of a cover.

A vehicle seat of this type is known from DE 694 02 438 T2 and EP 606 179 B1. DE 694 02 438 T2 and EP 606 179 B1 disclose a seat with a device for fastening the edge of the cover which covers a seat cushion to the outer wing of a depression or groove which borders a plate which is part of the seat framework, wherein the depression or groove is open outwards, as seen from the cushion, and comprises punched teeth for the purpose of locking to an outer lug.

DE 103 01 283 B3 discloses a rear seat backrest for a rear seat of a vehicle with a backrest frame, a rear wall attached thereto and a cover channel for the securing of the seat cover, wherein the backrest frame is composed of extruded profile parts and is formed in one piece with the cover channel, and wherein the rear wall is composed of an essentially planar component.

DE 20 2005 008 952 U1 discloses a retaining device for cover materials on padding materials in the region of a car seat, with a channel part, which is held in the padding material and has a receiving contour into which a shaped body can be introduced in the fitted position of the cover material, the shaped body taking hold of said cover material and having, in a single-piece design, a retaining part which can be fixed in the receiving contour and an extension part which engages at least in some regions behind the cover material stretched on the padding material.

Further vehicle seats and backrests are disclosed in DE 10 2005 005 485, DE 20 2004 019 560 U1, DE 101 42 981 A1, DE 202 04 180 U1, EP 0 875 4 16 A2, DE 101 26 014 C1, DE 100 22 984 A1, DE 101 53 156 A1, EP 1 413 475 A2 and DE 30 46 427 A1.

It is the object of the invention to provide an improved vehicle seat. In this case, it is desirable in particular to improve the padding for a vehicle seat. In addition, it is desirable to reduce the production costs for a vehicle seat.

The abovementioned object is achieved by a vehicle seat, in particular for a motor vehicle, wherein the vehicle seat comprises padding and a profile or panel which comprises a padding channel for the fastening of the padding and/or of a cover, and wherein the padding channel comprises a tab which protrudes into the padding channel or a tab which protrudes into the padding channel in such a manner that it increasingly narrows the latter in one section in the longitudinal direction of the padding channel.

A tooth disclosed in DE 694 02 438 T2 or EP 606 179 B1 is an exemplary embodiment of a tab within the context of the invention. In an advantageous refinement of the invention, the padding channel comprises at least two tabs which protrude into the padding channel and/or at least two tabs which protrude into the padding channel in such a manner that they increasingly narrow the latter in each case in one section or in some sections in the longitudinal direction of the padding channel. In a furthermore advantageous refinement of the invention, the padding channel comprises a plurality of tabs which protrude into the padding channel and/or a plurality of tabs which protrude into the padding channel in such a manner that they increasingly narrow the padding channel in one section in each case or in some sections in the longitudinal direction of the padding channel.

A profile within the context of the invention is in particular part of a fixed or shaping structure of a vehicle seat. Within the context of the invention, a profile may be part of a frame of a vehicle seat or a frame of a vehicle seat.

A panel within the context of the invention is in particular part of a fixed or shaping structure of a vehicle seat. Within the context of the invention, a panel may be a back panel for maintaining a survival space in a motor vehicle or part of a back panel of this type. Within the context of the invention, a panel may be a back panel which extends essentially over an entire backrest. Within this context, a back panel extends in particular essentially over the entire backrest if it extends essentially over the entire backrest in two orthogonal directions. Within the abovementioned context, a back panel extends in particular essentially over the entire backrest if it extends essentially over the entire backrest in the transverse direction of the motor vehicle and in the vertical direction. Within the abovementioned context, a back panel extends in particular essentially over the entire backrest if it extends essentially over the entire backrest in its longitudinal direction and in the vertical direction. A rear seat or a rear bench of a motor vehicle may include a divided or dividable backrest. In this case, a backrest for a rear seat of a motor vehicle within the abovementioned context is in particular part of the divided or dividable backrest.

A cover may be composed, for example, of leather, imitation leather, a textile or another customary material or may comprise leather, imitation leather, a textile or another customary material.

A padding channel may also be referred to as a cover channel. The groove disclosed in DE 694 02 438 T2 and EP 606 179 B1 is an exemplary embodiment of a padding or cover channel.

In a furthermore advantageous refinement of the invention, the or a tab extends as far as an opening of the padding channel 101 on the longitudinal side. In a furthermore advantageous refinement of the invention, the padding channel is formed in the profile or panel. In a furthermore advantageous refinement of the invention, the tab is punched out of a side wall of the padding channel, wherein the tab which is punched out of the side wall of the padding channel is advantageously bent into the padding channel.

In a furthermore advantageous refinement of the invention, the profile or panel, in particular including the padding channel, is rolled. Within the context of the invention, a rolled profile or panel is in particular a profile or panel produced by rolling. In this case, a substantial or largely predominant part of the (final) contour of the profile or panel is not produced by pressing or embossing but rather by rolling.

In a furthermore advantageous refinement of the invention, the padding channel is formed from steel. In a furthermore advantageous refinement of the invention, a cover material retaining means is arranged in the padding channel and is inserted in the direction on the longitudinal side. In one refinement, provision may be made for the padding channel to taper in the direction of an opening on the longitudinal side or in the region of the opening. In a further refinement, provision may be made for the opening on the longitudinal side or the tapered region to be not wider than 80%, in particular not wider than 60%, of the maximum width of the padding channel. In a furthermore advantageous refinement of the invention, the cross section of the padding channel has a continuous drawn-out profile.

In a furthermore advantageous refinement of the invention, the padding channel is formed in a back panel or part of a back panel, with the back panel, in a furthermore advantageous refinement of the invention, comprising at least two panels which are welded to each other and each have at least one padding channel.

In addition, the abovementioned object is achieved by a method for producing a vehicle seat in particular a vehicle seat comprising one or more of the abovementioned features, wherein the vehicle seat has padding and a profile or panel which comprises a padding channel for the fastening of the padding and/or of a cover, and wherein a tab is punched into the profile or panel and is bent into the padding channel in such a manner that it increasingly narrows the latter in one section, in particular in the longitudinal direction of the padding channel.

In an advantageous refinement of the invention, the padding channel is formed in the profile or panel. In a furthermore advantageous refinement of the invention, the profile or panel is formed by rolling. In a furthermore advantageous refinement of the invention, the padding channel is formed in the profile or panel by rolling. In a furthermore advantageous refinement of the invention, the padding and/or the cover is fastened in the padding channel with the use of the tab. In a furthermore advantageous refinement of the invention, in order to fasten the cover in the padding channel, a cover material retaining means is inserted in the direction on the longitudinal side.

A motor vehicle within the context of the invention is in particular a land vehicle which can be used individually in road traffic. Motor vehicles within the context of the invention are in particular not restricted to land vehicles with an internal combustion engine.

Further advantages and details emerge from the description below of exemplary embodiments. In the drawings:

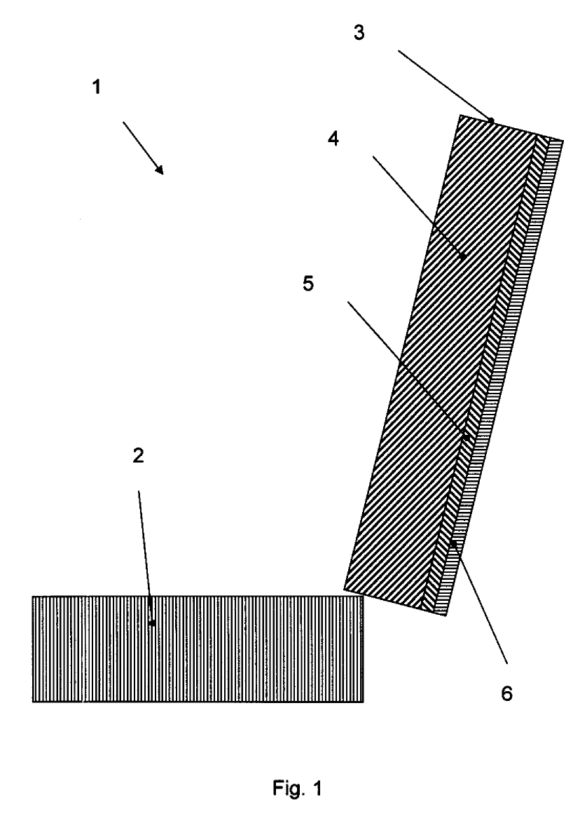

FIG. 1 shows a cross section through an exemplary embodiment of a vehicle seat of a motor vehicle in a simplified schematic illustration,

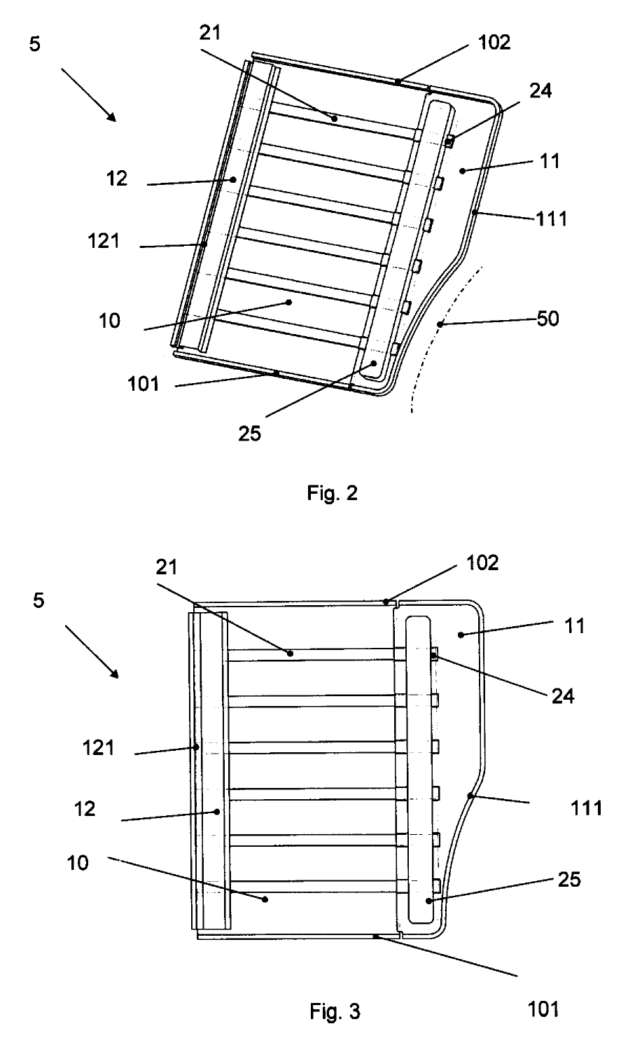

FIG. 2 shows an exemplary embodiment of a back panel for the backrest of a vehicle seat according to FIG. 1 in a perspective illustration,

FIG. 3 shows the back panel according to FIG. 2 in a plan view,

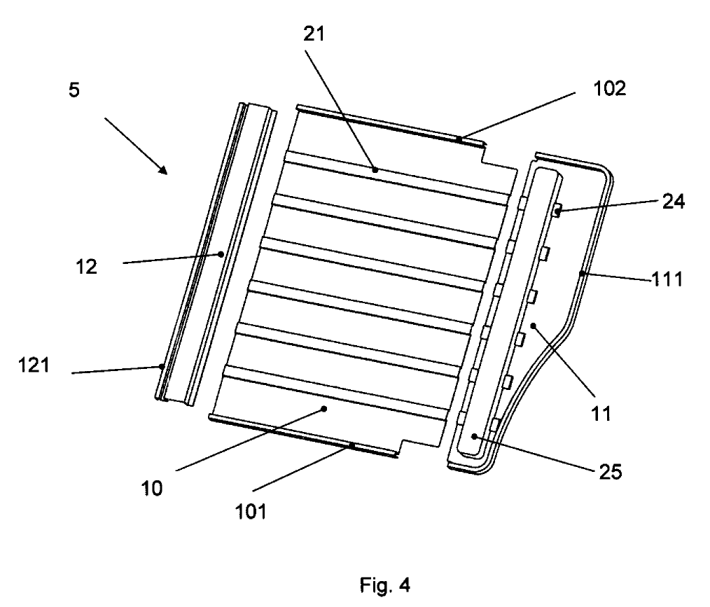

FIG. 4 shows the back panel according to FIG. 2 in an exploded illustration,

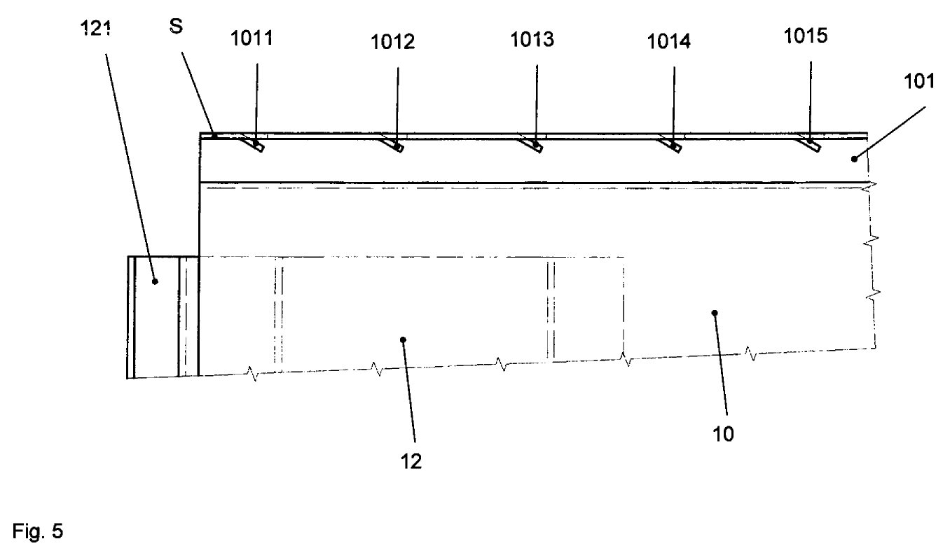

FIG. 5 shows a partial illustration of the back panel according to FIG. 2 in a rear view,

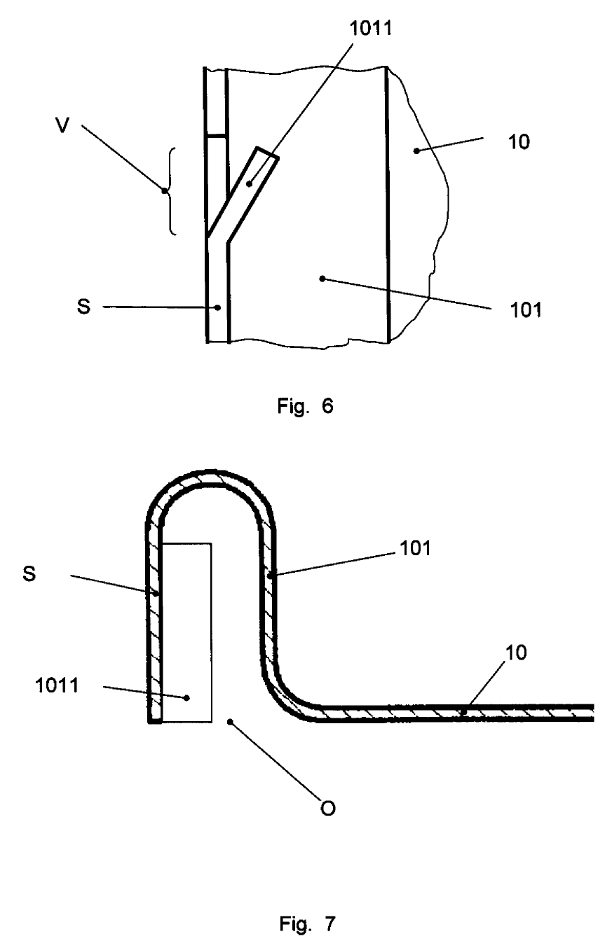

FIG. 6 shows a partial illustration of the illustration according to FIG. 5,

FIG. 7 shows a cross section through an exemplary embodiment of a padding channel,

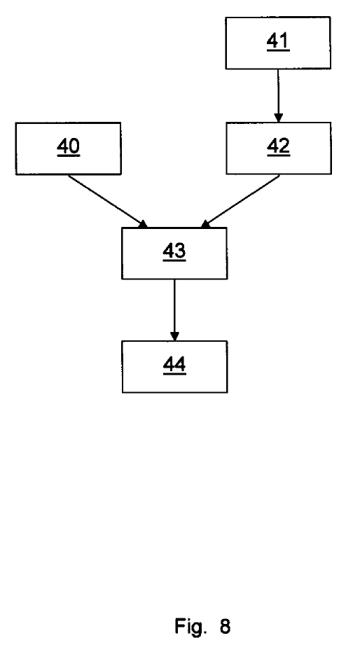

FIG. 8 shows an exemplary embodiment of a method for producing a backrest for a vehicle seat of a motor vehicle,

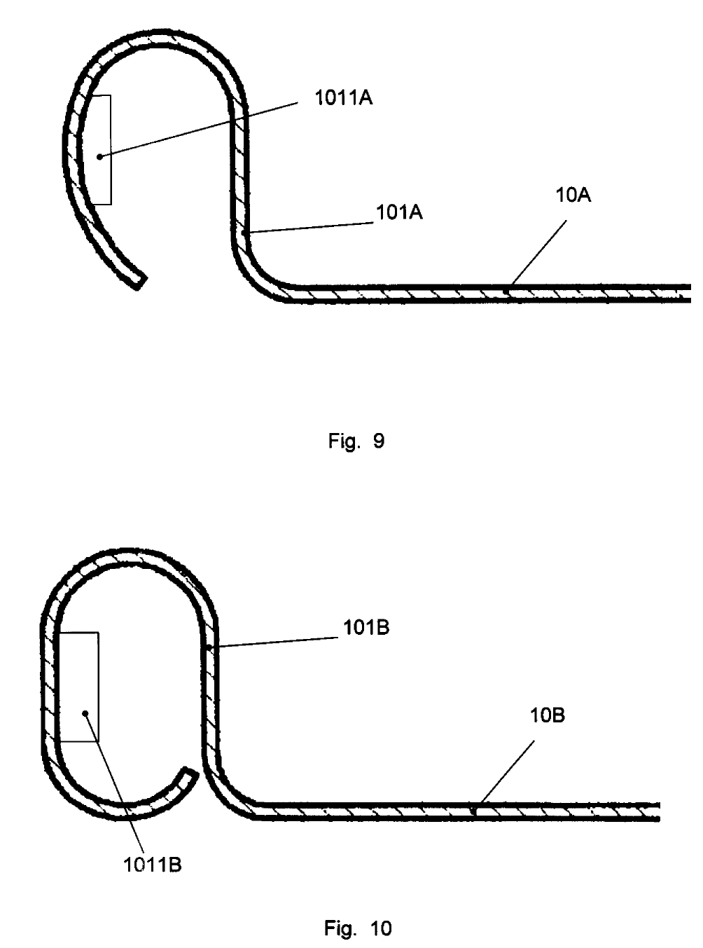

FIG. 9 shows a cross section through a further exemplary embodiment of a padding channel, and

FIG. 10 shows a cross section through a further exemplary embodiment of a padding channel.

FIG. 1 shows an exemplary embodiment of a cross section through an exemplary embodiment of a vehicle seat 1 of a motor vehicle in a simplified schematic illustration. The vehicle seat 1 comprises a seat part 2 and a backrest 3. The backrest 3 comprises padding 4 and a rear panel 5 arranged behind the padding 4. The padding 4 is surrounded at least partially by a cover (not illustrated), for example made of leather, imitation leather, a textile or another customary material. A lining 6, such as, for example, a cover, may be provided behind the rear panel 5. The backrest 3 may comprise a frame (not illustrated) which is connected to the rear panel 5. Examples of frames of this type are disclosed, for example, in DE 10 2005 005 485, DE 20 2004 019 560 U1 and DE 101 42 981 A1. In addition, the vehicle seat 1 comprises a head restraint (not illustrated). The elements in FIG. 1 are shown with consideration for simplicity and clarity and not necessarily true to scale. Thus, for example, the sizes of some of the elements in FIG. 1 are exaggerated in comparison to other elements in order to improve the understanding of the exemplary embodiment.

FIG. 2 shows an exemplary embodiment of the back panel 5 in a perspective illustration, FIG. 3 shows the back panel 5 in a plan view, and FIG. 4 shows the back panel in an exploded illustration. The back panel 5 comprises a rolled base plate 10 and a pressed side part 11 which is welded to the base plate 10. That side of the side part 11 which faces away from that side of the side part 11 which is connected to the base plate is matched to the contour 50 of a wheelhouse and/or chassis of the motor vehicle. In this case, the side part 11 is advantageously configured in such a manner that its width in the transverse direction of the motor vehicle varies by at least 20%. In the exemplary embodiment illustrated, the width of the side part 11 in the transverse direction of the motor vehicle varies by 45%, i.e. the smallest width of the side part 11 is 55% of the greatest width of the side part 11. The area of the base plate 10 is at least twice as large as the area of the side part 11.

Profiles or beads 21—which are formed by the rolling of the base plate 10—and which run in the transverse direction of the motor vehicle are formed in the base plate 10. Profiles 24 corresponding to the profiles or beads 21 are formed in the side part 11. In addition, a profile 25 which runs essentially vertically and essentially orthogonally to the profiles or beads 21 and is configured in the manner of a hat profile is formed in the side part 11.

In an advantageous refinement, the side part 11 is composed of a material having lower tensile strength than the material of the base plate 10. In a further advantageous refinement, the base plate 10 is composed of a steel with a tensile strength of at least 800 N/mm². In a further advantageous refinement, the sheet-metal thickness of the side part 11 is greater than the sheet-metal thickness of the base plate 10. In a further advantageous refinement, the base plate 10 is configured symmetrically in such a manner that a side part corresponding to the side part 11 can be welded either on the left or right to a corresponding base plate 10.

A padding channel 111 for the fastening of the padding 4 and/or of a cover is formed in part of the edge of the side part 11 and borders the side part 11 on three sides. A respective padding channel 102 and 101 for the fastening of the padding 4 and/or of a cover is likewise formed in the upper and the lower edge of the base plate 10. On that side of the base plate 10 which faces away from the side part 11, the back panel 5 comprises a profile support 12 which is configured as a hat profile, is welded to the base plate 10 and comprises a padding channel 121 for the fastening of the padding 4 and/or of a cover.

FIG. 5 shows a partial illustration of the back panel 5 in a rear view in the region of the padding channel 101, and FIG. 6 shows a partial illustration of the illustration according to FIG. 5. FIG. 7 shows a cross section through the padding channel 101. The padding channel 101 comprises a plurality of tabs 1011, 1012, 1013, 1014, 1015 which are punched into a side wall S of the padding channel 101 and are bent into the padding channel 101 in such a manner that they protrude into the padding channel 101 and increasingly narrow it in one section V or in some sections in its longitudinal direction. In the exemplary embodiment illustrated, it is provided that the tabs 1011, 1012, 1013, 1014, 1015 extend as far as an opening O on the longitudinal side of the padding channel 101. The padding channels 102 and 121 may be configured in a corresponding manner.

FIG. 8 shows an exemplary embodiment of a method for producing the vehicle seat 1 and a method for producing a backrest for a vehicle seat of a motor vehicle, such as, for example, the backrest 5. In this case, the side part is pressed in a step 40. In a step 41 for producing the base plate 10, a steel band is rolled, with the padding channels 101, 102 and also the beads 21 being formed in the steel band and therefore in the later base plate 10 by rolling. In addition, the tabs 1011, 1012, 1013, 1014, 1015 are punched into the side wall S of the padding channel 101 and bent into the padding channel 101. Step 41 is followed by step 42 in which the base plate 10 is cut off from the rolled steel band. However, provision may also be made for the padding channels 101, 101A, 102 to merely be preformed during the rolling operation and to be shaped subsequently, if appropriate after the cutting operation, into their final shape.

A step 43 follows, in which the base plate 10 and the side part 11 are welded, screwed or riveted to each other to form a back panel 5. Furthermore, the profile support 12 is welded to the base plate 10. In order to produce a back panel for a backrest which is not divided or is not dividable, it is advantageously provided that, instead of the profile support 12 provided with a padding channel 121, a side part corresponding to the side part 11 (but “mirror-inverted”) is welded, screwed or riveted to the base plate 10. If appropriate, a frame is welded to the back panel 5. Step 43 is followed by a step 44, in which the back panel 5 is upholstered, with a cover being fastened or retained in the padding channels 101, 102, 111, 121, in particular with the use of the tabs 1011, 1012, 1013, 1014, 1015. The method described may also be used, with the use of the advantageously configured padding channel 101, for the padding of the seat part 2.

FIG. 9 and FIG. 10 show cross sections through further exemplary embodiments of base plates 10A and 10B with padding channels 101A and 101B configured in an alternative manner to the padding channel 101. The padding channels 101A and 101B likewise each have a plurality of tabs 1011A and 1011B which are punched into a side wall and bent into the padding channel 101A and 101B, protrude into the padding channel 101A and 101B and increasingly narrow said padding channel 101A and 101B at least in some sections in its longitudinal direction.

### LIST OF DESIGNATIONS

1 Vehicle seat
2 Seat part
3 Backrest
4 Padding
5 Back panel
6 Lining
10, 10A, 10B Base plate
11 Side part
12 Profile support
21 Bead
24 Profile corresponding to beads
25 Profile running orthogonally with respect to beads
40, 41, 42, 43, 44 Step
50 Contour
101, 101A, 101B, 102, 111, 121 Padding channel
1011, 1011A, 1011B, 1012, 1013, 1014, 1015 Tab
O Opening
S Side wall
V Section

1. Vehicle seat, the vehicle seat comprising
padding and
one of the group consisting of
a profile which comprises a padding channel for the fastening of the padding or a cover and
a panel which comprises a padding channel for the fastening of the padding or a cover,
wherein the padding channel comprises a tab which protrudes into the padding channel in such a manner that it increasingly narrows the latter in one section in the longitudinal direction of the padding channel.

2. Vehicle seat according to claim 1, wherein the padding channel is formed in the profile or panel.

3. Vehicle seat according to claim 1, wherein the tab is punched out of a side wall of the padding channel.

4. Vehicle seat according to claim 3, wherein the tab which is punched out of the side wall of the padding channel is bent into the padding channel.

5. Vehicle seat according to claim 1, wherein the profile or panel, in particular including the padding channel, is rolled.

6. Vehicle seat according to claim 1, wherein in that the padding channel is formed from steel.

7. Vehicle seat according to claim 1, wherein the padding channel is formed in a back panel or part of a back panel.

8. Vehicle seat according to claim 7, wherein the back panel comprises at least two panels which are welded to each other and each have at least one padding channel.

9. Method for producing a vehicle seat with padding and a profile or panel which comprises a padding channel for the fastening of the padding or a cover, the method comprising:
punching a tab into a profile or panel
bending the tab into the padding channel in such a manner that it increasingly narrows the latter in a section of the padding channel.

10. Method according to claim 9, the method further comprising:
forming the padding channel in the profile or panel.

11. Method according to claim 9, the method further comprising:
forming the profile or panel by rolling.

12. Method according to claim 11, the method further comprising:
forming the padding channel in the profile or panel by rolling.
